(19) United States
(12) Patent Application Publication
(10) Pub. No.: US 2014/0372915 A1
(43) Pub. Date: Dec. 18, 2014

(54) METHOD AND SYSTEM FOR OPERATING DISPLAY DEVICE

(71) Applicant: Shao-Tsu Kung, Taipei City (TW)

(72) Inventor: Shao-Tsu Kung, Taipei City (TW)

(73) Assignee: COMPAL ELECTRONICS, INC., Taipei City (TW)

(21) Appl. No.: 14/303,613

(22) Filed: Jun. 13, 2014

(30) Foreign Application Priority Data
Jun. 13, 2013 (TW) 102120928

(51) Int. Cl. G06F 3/0481; G06F 3/14; G06F 3/0488

(52) U.S. Cl. CPC G06F 3/04817; G06F 3/0488; G06F 3/1423
USPC 715/761

(57) ABSTRACT

A method and a system for operating a display device are provided. In a handheld electric device, a picture displayed in the display device is shown by a transparent touch panel, and a touch signal is received by the transparent touch panel for obtaining a corresponding touch data, moreover, the touch data is transmitted to the display device by a wireless communication unit of the handheld electric device. The display device obtains a relative icon displayed in the display device according to the touch data so as to execute an action corresponding to the relative icon.

### CROSS-REFERENCE TO RELATED APPLICATION

This application claims the priority benefit of Taiwan application serial no. 102120928, filed on Jun. 13, 2013. The entirety of the above-mentioned patent application is hereby incorporated by reference herein and made a part of this specification.

### BACKGROUND

1. Field of the Invention

The disclosure relates to a method and system for operating display device. More particularly, the disclosure relates to a method and system for operating display device employing a transparent touch panel of a handheld electronic device to remotely control a display content.

2. Description of Related Art

Along with development of technology, functions of electronic devices become more and more powerful, and people increasingly depend of the electronic devices in daily life. Herein along with the developing trend of the electronic devices becoming more and more user-friendly and better functioned, handheld electronic devices, such as mobile phones, personal digital assistants (PDAs), tablet computers or the like, are generally disposed with a touch panel, and users can directly touch any of the function items displayed on the touch screen with the finger or by using a stylus for operating.

At present, the touch panels can be generally classified into resistive, capacitive, optical, and ultrasonic touch panels, wherein the optical touch panels and the capacitive touch panels are most common products. The capacitive touch panels have a multi-touch feature, which allows a more user-friendly operation mode. Therefore, the capacitive touch panels are gradually favored by the market.

### SUMMARY OF THE INVENTION

The disclosure provides a method and system for operating display device employing a handheld electronic device for operating a display device.

The method for operating a display device is adapted to operate a display device via a handheld electronic device with a transparent touch panel. The method includes: a picture displayed in the display device is shown by the transparent touch panel of the handheld electronic device; a touch signal is received by the transparent touch panel of the handheld electronic device for obtaining a corresponding touch data; the touch data is transmitted to the display device by a wireless communication unit of the handheld electronic device; and a relative icon displayed in the display device is obtained according to the touch data by the display device so as to execute an action corresponding to the relative icon.

According to one exemplary embodiment of the disclosure, the handheld electronic device includes an image capturing unit, and the touch data is an image data. In the step of showing the picture displayed in the display device by the transparent touch panel of the handheld electronic device, the picture is received by the image capturing unit and the picture is shown on the transparent touch panel.

According to one exemplary embodiment of the disclosure, in the step of receiving the touch signal by the transparent touch panel of the handheld electronic device for obtaining the corresponding touch data, the touch coordinate of the touch signal in the transparent touch panel is transformed into an image coordinate of the image capturing unit, and the image data correspondingly received in the image coordinate is captured by the image capturing unit.

According to one exemplary embodiment of the disclosure, the step of obtaining the relative icon displayed in the display device according to the touch data by the display device is that the image data is compared with a plurality of display icons displayed in the display device for finding out the relative icon compatible with the image data.

The method for operating a display device is adapted to operate a display device via a handheld electronic device with a transparent touch panel. The method includes: the handheld electronic device is positioned by a plurality of positioning receiving units thereof and a plurality of positioning emitting units of the display device, so that a picture displayed in the display device is shown by the transparent touch panel of the handheld electronic device; a touch signal is received by the transparent touch panel of the handheld electronic device for obtaining a corresponding touch data; the touch data is transmitted to the display device by a wireless communication unit of the handheld electronic device; and a relative icon displayed in the display device is obtained according to the touch data by the display device so as to execute an action corresponding to the relative icon.

According to one exemplary embodiment of the disclosure, the step of positioning includes: the positioning receiving units of the handheld electronic device receive the positioning signals from the positioning emitting units respectively, the received positioning signals are compared with a predetermined value of each positioning signal respectively by the handheld electronic device; it is determined that positioning is successful if each of the positioning signals is compatible with the corresponding predetermined value, the entire picture displayed in the display device is shown by the transparent touch panel of the handheld electronic device; a notification message is indicated if at least one of the positioning signals is incompatible with the corresponding predetermined value.

According to one exemplary embodiment of the disclosure, the touch data is a touch coordinate. According to one exemplary embodiment of the disclosure, the step of obtaining a relative icon displayed in the display device according to the touch data by the display device is that the touch coordinate is transformed into a display coordinate of the display device, and the relative icon is obtained according to the display coordinate.

The system for operating a display device of the disclosure includes display device and a handheld electronic device. The display device includes a plurality of positioning emitting units for respectively emitting a plurality of positioning signals and a first wireless communication unit. The handheld electronic device includes a transparent touch panel which receives a touch signal, a plurality of positioning receiving units which receive the positioning signals from the positioning emitting unit for positioning, and a second wireless communication unit. Herein the handheld electronic device obtains a corresponding touch data according to the touch signal, and the touch data is transmitted to the display device by the second wireless communication unit. The touch data is received by the first wireless communication unit of the display device, and a relative icon displayed in the display device is obtained according to the touch data so as to execute an action corresponding to the relative icon.

According to one exemplary embodiment of the disclosure, the positioning emitting units are infrared emitting units, the positioning receiving units are infrared receiving units, and the positioning signal is an infrared.

In light of the above, the picture displayed in the remote display device is displayed by the transparent touch panel in the disclosure, and the transparent touch panel can be used to remotely control the display content of the display device. Accordingly, the users can remotely operate the display device.

To make the above features and advantages of the present invention more comprehensible, several embodiments accompanied with drawings are described in detail as follows.

### BRIEF DESCRIPTION OF THE DRAWINGS

The accompanying drawings constituting a part of this specification are incorporated herein to provide a further understanding of the disclosure. Here, the drawings illustrate embodiments of the disclosure and, together with the description, serve to explain the principles of the disclosure.

FIG. 1 is a block diagram showing a system for operating a display device according to the first embodiment of the disclosure.

FIG. 2 is a flowchart of a method for operating a display device according to the first embodiment of the disclosure.

FIG. 3 is a schematic side view showing the arrangement of the system for operating a display device according to the first embodiment of the disclosure.

FIG. 4 is a schematic view showing a system for operating a display device according to the second embodiment of the disclosure.

FIG. 5 is a flowchart of a method for operating a display device according to the second embodiment of the disclosure.

FIG. 6 is a flowchart of another method for operating a display device according to the second embodiment of the disclosure.

FIG. 7 is a schematic view showing a system for operating a display device according to the third embodiment of the disclosure.

FIG. 8 is a flowchart of a method for operating a display device according to the third embodiment of the disclosure.

### DESCRIPTION OF EMBODIMENTS

In order to make the disclosure more comprehensible, embodiments are described below as the examples to prove that the disclosure can actually be realized. Wherever possible, the same reference numbers are used in the drawings and the description to refer to the same or like parts. However, the embodiments described below are only examples and are not intended to limit the scope of the present invention, and the characteristics mentioned in each embodiment or a combination thereof can be implemented without departing the scope and spirit of the present invention.

### First Embodiment

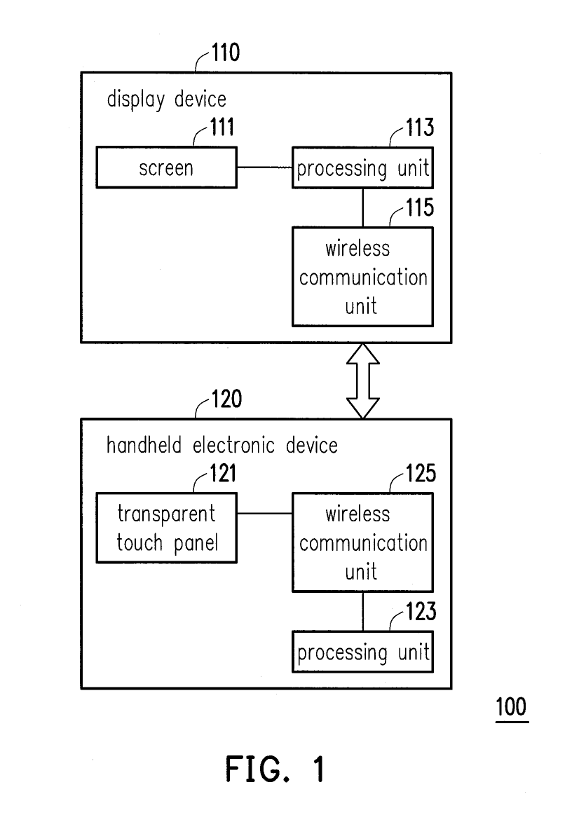

FIG. 1 is a block diagram showing a system for operating a display device according to the first embodiment of the disclosure. The system for operating a display device 100 includes a display device 110 and a handheld electronic device 120. Herein the display device 110 is disposed with a screen 111 and includes a processing unit 113 and a wireless communication unit 115. The handheld electronic device 120 includes a transparent touch panel 121, a processing unit 123 and a wireless communication unit 125. Herein the display device 110 communicates with the wireless communication unit 125 of the handheld electronic device 120 via the wireless communication unit 115. For example, the handheld electronic device 120 may be a tablet computer, a smart phone or the like, and the display device 110 may be a display apparatus integrated with a host, a television integrated with a host, or the like.

In other embodiments, the display device 110 may also merely disposed with a screen 111 and a wireless communication unit 115, while the processing unit 113 is disposed in the host which is connected with the display device 110. For example, the display device 110 is a display apparatus of a personal computer (PC).

In addition, for example, the wireless communication unit 115 and the wireless communication unit 125 may be wireless fidelity (WiFi) modules, Bluetooth modules, wireless network cards, or the like.

Herein the handheld electronic device 120 is arranged in front of the display device 110, so that a picture displayed on the screen 111 of the display device 110 is shown by the transparent touch panel 121. The handheld electronic device 120 uses the wireless communication unit 125 to transmit the touch data to the wireless communication unit 115 of the display device 110, so that an icon displayed by the screen 111 of the display device 110 may be operated by operating the transparent touch panel 121.

In order to further illustrate the method and steps for operating the display device 110, the system for operating display device 100 is enumerated for more detailed description below.

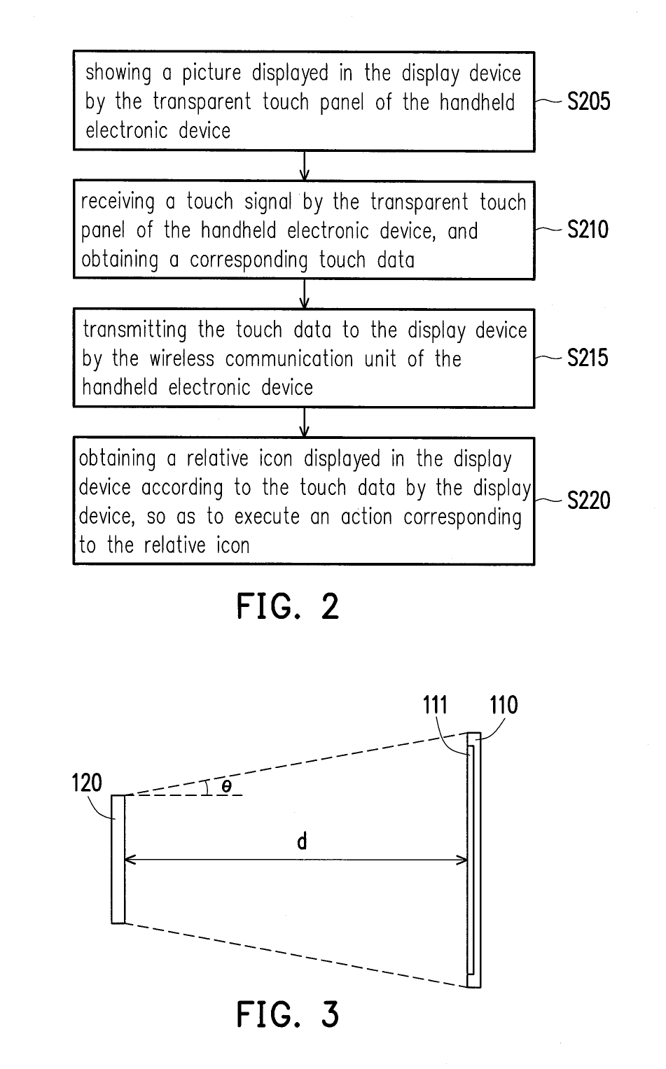

FIG. 2 is a flowchart of a method for operating a display device according to the first embodiment of the disclosure. Referring FIG. 1 and FIG. 2 together, in the step S205, the handheld electronic device 120 shows a picture displayed in the display device 110 via the transparent touch panel 121. For example, a user puts the handheld electronic device 120 in front of the display device 110, and then the picture is projected to the transparent touch panel 121.

An example is shown below for illustrating the position relation between the arrangements of the handheld electronic device 120 and the display device 110. FIG. 3 is a schematic side view showing the arrangement of the system for operating a display device according to the first embodiment of the disclosure. The present embodiment is exemplarily described in a view from the side.

Referring to FIG. 3, the handheld electronic device 120 is arranged in front of the screen 111 of the display device 110, so that the picture can be projected to the transparent touch panel 121 of the handheld electronic device 120. When the handheld electronic device 120 is arranged in an appropriate position, the entire screen 111 of the display device 110 can be displayed in the transparent touch panel 121 of the handheld electronic device 120. Herein a distance d is formed between the display device 110 and the handheld electronic device 120, and a corresponding angle θ is formed between the display device 110 and the handheld electronic device 120.

Then, in the step S210, a touch signal is received by the transparent touch panel 121 of the handheld electronic device 120, and a corresponding touch data is obtained. Herein, for example, the transparent touch panel 121 can be touched by using an object such as a finger, a stylus, or the like for thereby generating a touch signal. Next, the processing unit 123 receives the touch signal through the transparent touch panel 121, and further obtains a corresponding touch data from the touch signal. The touch data is a touch coordinate that is the location of the touch signal in the transparent touch panel 121, or the touch data is an image data shown in the transparent touch panel 121 corresponding to the touch signal.

After the corresponding touch data is obtained, as shown in the step S215, the touch data is transmitted to the display device 110 by the wireless communication unit 125 of the handheld electronic device 120. When the touch data is received by the wireless communication unit 115 of the display device 110, in the step S220, the display device 110 obtains a relative icon displayed in the display device 110 according to the touch data so as to execute an action corresponding to the relative icon. For example, assuming the touch data is a touch coordinate, the touch coordinate is transformed into a display coordinate of the display device 110, namely the display coordinate of the screen 111, by the processing unit 113 of the display device 110, after that the relative icon is obtained according to the display coordinate. Further, for example, assuming the touch data is an image data, the image data is compared with the plurality of display icons displayed in the display device 110 respectively by the processing unit 113 of the display device 110, so as to find out the relative icon which is compatible with the image data. After the processing unit 113 of the display unit 110 analyzes the touch data and obtains the relative icon, then the action corresponding to the relative icon can be executed.

In brief, the picture displayed in the remote display device 110 can be shown by the transparent touch panel 121. As such, the user can directly touch and operate the transparent touch panel 121, after that the corresponding touch data is transmitted to the display device 110, so that according to the touch data the display device 110 can know that the user wants to operate which icon, so that the corresponding action can be executed.

Several embodiments are listed below to illustrate the application of the abovementioned method.

### Second Embodiment

The present embodiment is one of the applications of the first embodiment. In the present embodiment, a plurality of positioning emitting units and a plurality of positioning receiving units are respectively disposed in the display device 110 and the handheld electronic device 120, so that before the display device 110 is operated by the handheld electronic device 120, a positioning process is executed by using the positioning receiving units of the handheld electronic device 120 and the positioning emitting units of the display device 110, in order that the display device 110 can more precisely analyze the touch data transmitted by the handheld electronic device 120. For example, the positioning emitting units and the positioning receiving units are light emitting units and light receiving units respectively, or the positioning emitting units and the positioning receiving units are infrared emitting units and infrared receiving units respectively, but the present disclosure is not limited thereto.

For the convenience of description, three positioning emitting units and three positioning receiving units are illustrated below as an example, and in other embodiments, the quantity of the positioning emitting units and the positioning receiving units is not limited.

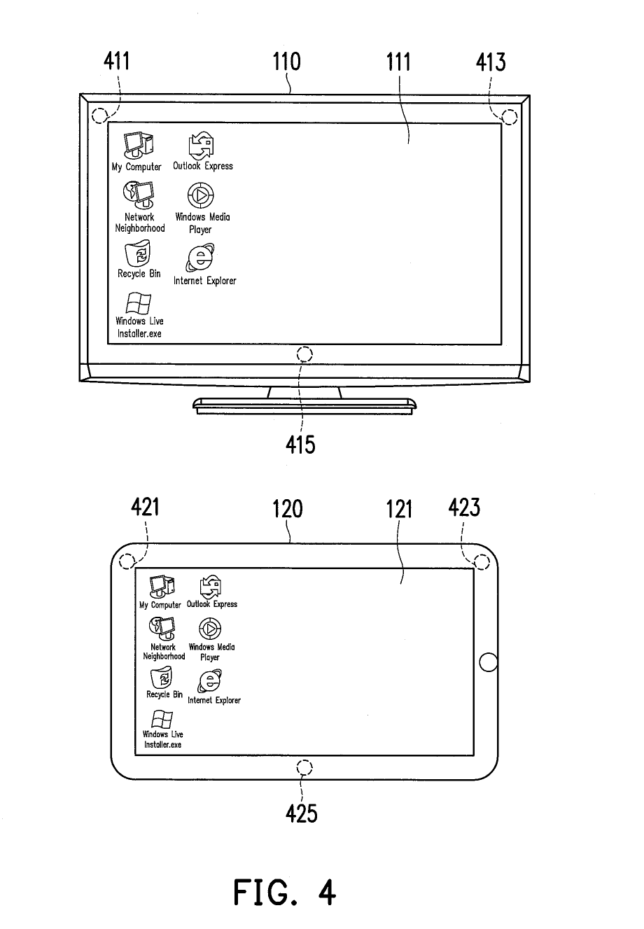

FIG. 4 is a schematic view showing a system for operating a display device according to the second embodiment of the disclosure. The present embodiment is the application of FIG. 1. Referring to FIG. 1 and FIG. 4, in the embodiment, the display device 110 further includes positioning emitting units 411, 413, 415, and the handheld electronic device 120 further includes positioning receiving units 421, 423, 425. In addition, other components in the internal of the display device 110 and the handheld electronic device 120 are similar to that of the system for operating display device 100 of the first embodiment, and they are omitted herein.

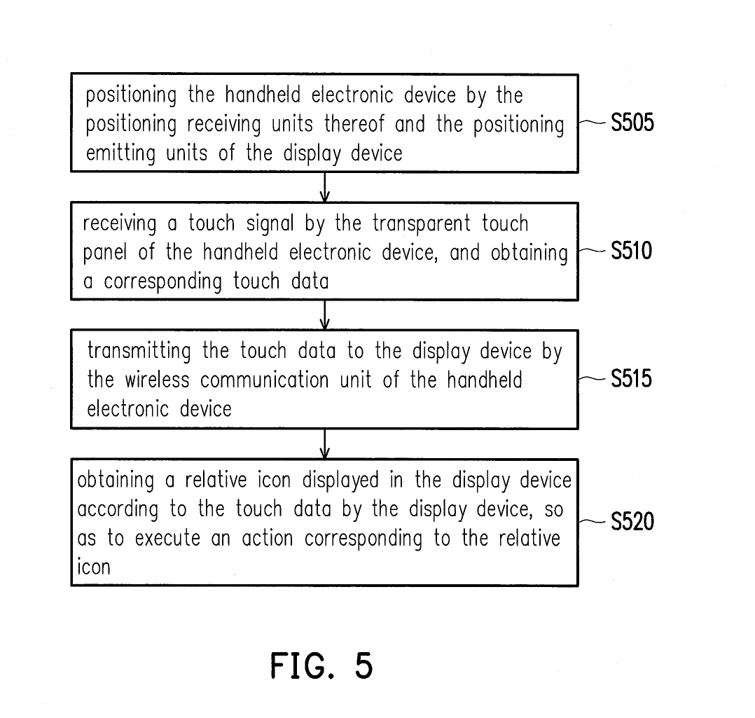

FIG. 5 is a flowchart of the method for operating a display device according to the second embodiment of the disclosure. Referring to FIG. 4 and FIG. 5, in the step S505, the handheld electronic device 120 is positioned by the positioning receiving units 421, 423, 425 thereof and the positioning emitting units 411, 413, 415 of the display device 110, so that the picture is shown by the transparent touch panel 121 of the handheld electronic device 120.

After positioning is accomplished, in the step S510, a touch signal is received by the transparent touch panel 120 of the handheld electronic device 120, and a corresponding touch data is obtained. After that, in the step S515, the touch data is transmitted to the display device 110 by the wireless communication unit 125 of the handheld electronic device 120. And in the step S520, the display device 110 obtains a relative icon displayed in the display device 110 according to the touch data so as to execute an action corresponding to the relative icon.

In the following the touch data is taken as the touch coordinate which is the location of the touch signal in the transparent touch panel 121, in order to further illustrate each step of the method for operating the display device 110.

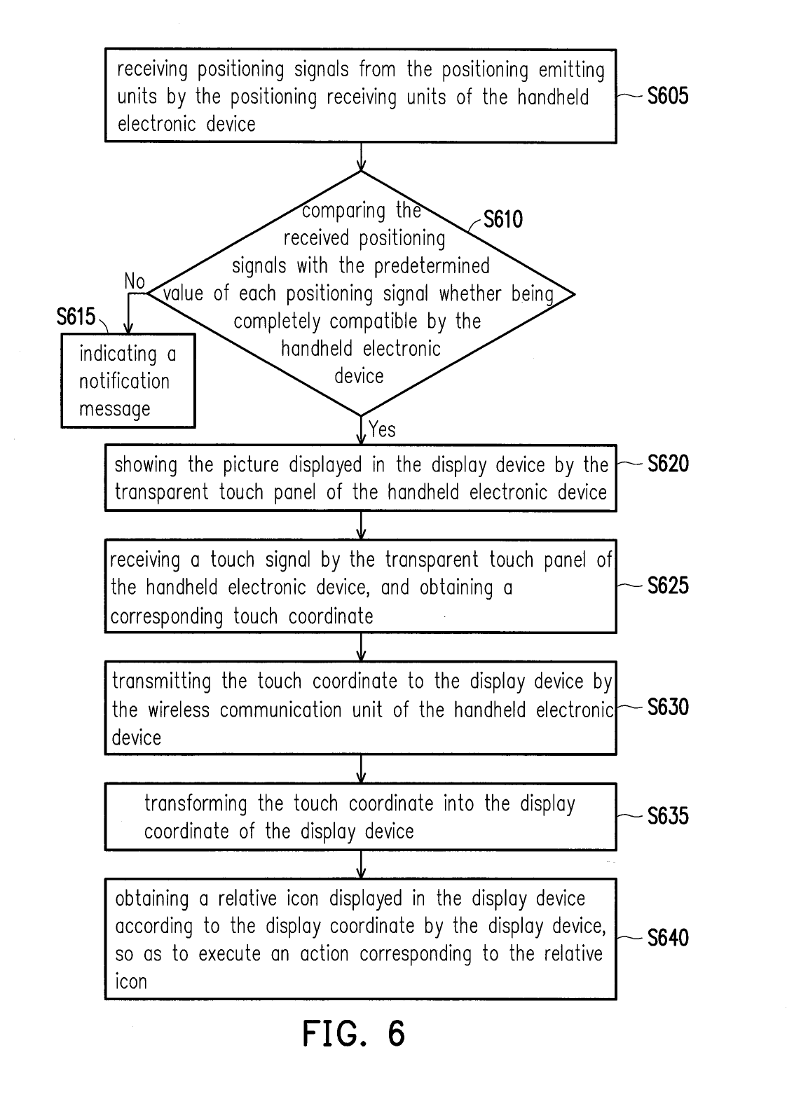

FIG. 6 is a flowchart of another method for operating a display device according to the second embodiment of the disclosure. Referring to FIG. 1, FIG. 4 and FIG. 6, in the step S605, the positioning receiving units 421, 423, 425 of the handheld electronic device 120 receives a plurality of positioning signals from the positioning emitting units 411, 413, 415 respectively. When the positioning receiving units 421, 423, 425, and the positioning emitting units 411, 413, 415 are light receiving units and light emitting units respectively, the positioning signals are light signals. When the positioning receiving units 421, 423, 425, and the positioning emitting units 411, 413, 415 are infrared receiving units and infrared emitting units respectively, the positioning signals are infrareds.

Next, in the step S610, the received positioning signals are compared with a predetermined value of each positioning signal by the handheld electronic device 120. If one of the positioning signals is incompatible with the corresponding predetermined value, as shown in the step S615, a notification message is indicated in the handheld electronic device 120, as such the user is informed to move the handheld electronic device 120 for executing the positioning process again. For example, the user adjusts the position of the handheld electronic device 120, such that the positioning receiving units 421, 423, 425 receive a plurality of new positioning signals from the positioning emitting units 411, 413, 415, and the step S605 is repeatedly executed. On the other hand, it is determined that positioning is successful if each of the positioning signals is compatible with the corresponding predetermined value, as shown in the step S620, then the entire picture displayed in the display device 110 is shown by the transparent touch panel 121 of the handheld electronic device 120. Next, the steps S625 to S640 are executed.

In the step S625, the touch signal is received by the transparent touch panel 121 of the handheld electronic device 120, and a corresponding touch coordinate is obtained. After that, in the step S630, the touch coordinate is transmitted to the display device 110 by the wireless communication unit 125 of the handheld electronic device 120. In the step S635, the touch coordinate is transformed into the display coordinate of the display device 110 by the processing unit 113 of the display device 110. In the step S640, the processing unit 113 of the display device 110 obtains the relative icon according to the display coordinate.

Taking FIG. 3 as an example, when it is assumed that the positioning receiving units 421, 423, 425, and the positioning emitting units 411, 413, 415 are light receiving units and light emitting units respectively, the positioning is performed according to whether the light intensity of the received light signal (positioning signal) is compatible with the predetermined value. After the positioning is accomplished, the distance d and the angle θ may become a fixed value. A coordinate converting equation for the coordinates between the screen 111 and the transparent touch panel 121 which are obtained from the distance d and the corresponding angle θ can be installed in advance in the display device 110. Accordingly, after the display device 110 obtains the touch coordinate, the processing unit 113 can transform the touch coordinate into the display coordinate of the display device 110 by using the coordinate converting equation.

In summary, after the positioning is accomplished, the touch coordinate can be precisely transformed into the display coordinate of the display device 110. Accordingly, the display device 110 can be remotely operated via the transparent touch panel 121.

### The Third Embodiment

The present embodiment is another application of the first embodiment. In the embodiment, an image capturing unit is disposed in the handheld electronic device 120 for receiving the picture displayed in the display device 110, and the picture received by the image capturing unit is shown on the transparent touch panel 121.

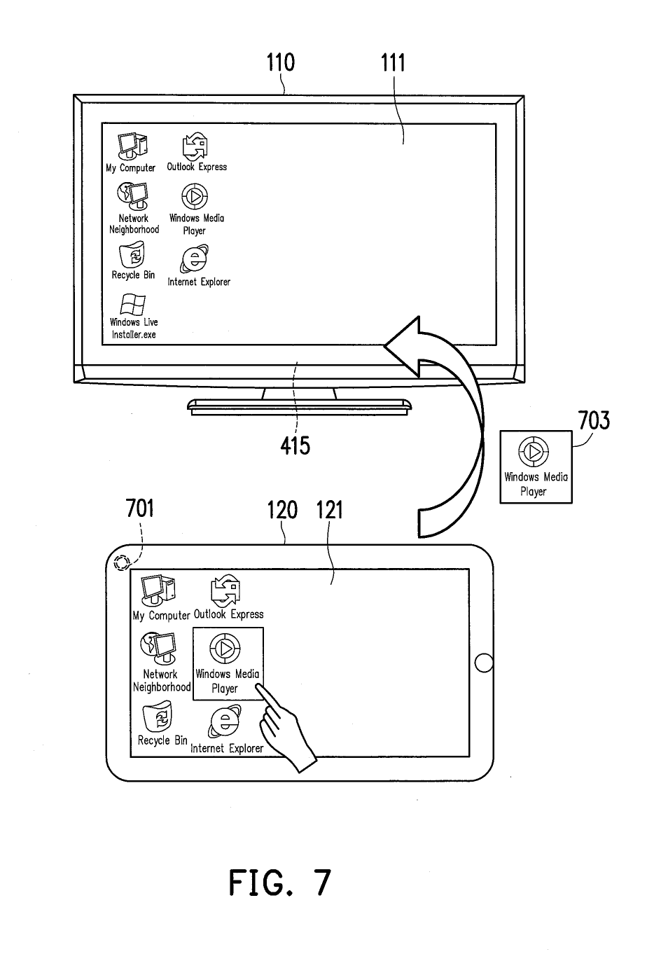

FIG. 7 is a schematic view showing a system for operating a display device according to the third embodiment of the disclosure. The present embodiment is the application of FIG. 1. Referring to FIG. 1 and FIG. 7, in the present embodiment, the handheld electronic device 120 further includes an image capturing unit 701. In addition, other components in the internal of the display device 110 and the handheld electronic device 120 are similar to that of the system for operating display device 100 of the first embodiment, and they are omitted herein.

As shown in FIG. 7, the remote display device 110 is targeted by the image capturing unit 701 (e.g., disposed at the back of the handheld electronic device 120), such that a portion of the picture can be shown on the transparent touch panel 121 of the handheld electronic device 120.

The user can touch the transparent touch panel 121 by using an object such as a finger, a stylus, or the like. For example, once the transparent touch panel 121 is touched, the processing unit 123 of the handheld electronic device 120 receives the touch signal from the transparent touch panel 121, and an image data (e.g., the picture 703) corresponding to the touch signal is transmitted to the display device 110. The display device 110 further obtains a relative icon compatible with the image data by comparison, so as to execute a corresponding action.

An embodiment is further shown below for detailed illustration of the method for operating display device and the processing steps thereof in which the image data is taken as the touch data.

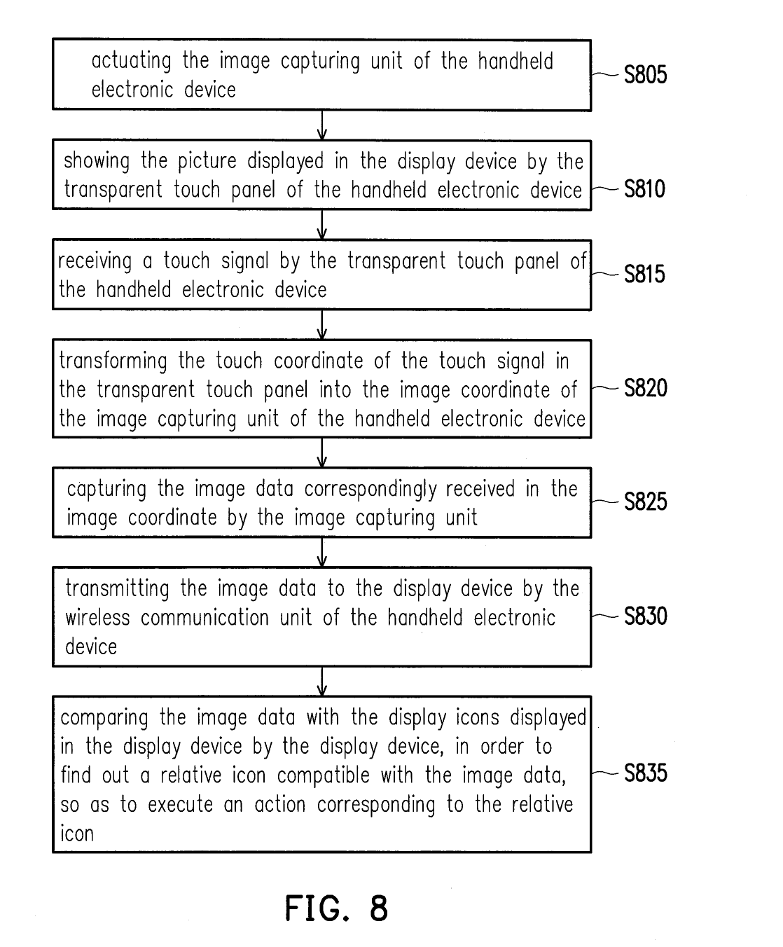

FIG. 8 is a flowchart of a method for operating a display device according to the third embodiment of the disclosure. Referring to FIG. 1, FIG. 7 and FIG. 8, herein the touch data obtained according to the touch signal received by the transparent touch panel 121 is an image data, i.e., the touch signal corresponds to the image data shown in the transparent touch panel 121.

First, in the step S805, the image capturing unit 701 of the handheld electronic device 120 is actuated. Next, in the step S810, the picture displayed in the display device 110 is shown by the transparent touch panel 121 of the handheld electronic device 120. In other words, the picture is received by the image capturing unit 701, and the picture is shown on the transparent touch panel 121.

Then, in the step S815, a touch signal is received by the transparent touch panel 121 of the handheld electronic device 120. For example, the user uses a finger to touch one of the icons shown on the transparent touch panel 121.

Next, in the step S820, the handheld electronic device 120 transforms the touch coordinate of the touch signal in the transparent touch panel 121 into an image coordinate of the image capturing unit 701. And in the step S825, the image data correspondingly received in the image coordinate is captured by the image capturing unit 701. Namely, the touch coordinate is transformed into the image coordinate of the image capturing unit 701 by the processing unit 123 of the handheld electronic device 120, and the image data (e.g., the picture 703) corresponding to the image coordinate is captured by the image capturing unit 701.

For example, the image capturing unit 701 can recognizes the relative icon which is in the image coordinate and automatically captures the image data from an appropriate range. Or a coordinate range is predetermined, so that the image data within the predetermined coordinate range is captured by using the image coordinate as a center.

After that, in the step S830, the image data is transmitted to the display device 110 by the wireless communication unit 125 of the handheld electronic device 120. When the image data is received by the wireless communication unit 115 of the display device 110, in the step S835, the display device 110 compares the image data with a plurality of image icons displayed in the display device 110, in order to find out a relative icon compatible with the image data, so as to execute an action corresponding to the relative icon.

In light of the foregoing, in the abovementioned embodiments, the picture displayed in the remote display device is displayed by the transparent touch panel in the disclosure, and the transparent touch panel can be directly used to remotely control the display content of the display device. Accordingly, the users can remotely operate the display device, so that the operating process becomes more interesting. In addition, the abovementioned embodiments can be employed in conditions that a large display device is used, such as conference, presentation, or the like, and the convenience of use is further enhanced. The user is not necessary to be in front of the display device for operating, and can control the content displayed in the display device just by using the handheld electronic device held in hand, and it is very convenient.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A method for operating a display device, adapted to operate the display device via a handheld electronic device with a transparent touch panel, the method comprising:
showing a picture displayed in the display device by the transparent touch panel of the handheld electronic device;
receiving a touch signal by the transparent touch panel of the handheld electronic device for obtaining a corresponding touch data;
transmitting the touch data to the display device by a wireless communication unit of the handheld electronic device; and
obtaining a relative icon displayed in the display device according to the touch data by the display device so as to execute an action corresponding to the relative icon.

2. The method as claimed in claim 1, wherein the handheld electronic device comprises an image capturing unit, and the touch data comprises an image data.

3. The method as claimed in claim 2, wherein the step of showing the picture by the transparent touch panel of the handheld electronic device comprises:
receiving the picture displayed in the display device by the image capturing unit, and showing the picture on the transparent touch panel.

4. The method as claimed in claim 2, wherein the step of receiving the touch signal by the transparent touch panel of the handheld electronic device for obtaining the corresponding touch data comprises:
transforming a touch coordinate of the touch signal in the transparent touch panel into an image coordinate of the image capturing unit; and
capturing the image data correspondingly received in the image coordinate by the image capturing unit.

5. The method as claimed in claim 2, wherein the step of obtaining the relative icon displayed in the display device according to the touch data by the display device comprises:
comparing the image data with a plurality of display icons displayed in the display device for finding out the relative icon compatible with the image data.

6. A method for operating a display device, adapted to operate a display device via a handheld electronic device with a transparent touch panel, the method comprising:
positioning the handheld electronic device by a plurality of positioning receiving units of the handheld electronic device and a plurality of positioning emitting units of the display device, so that a picture displayed in the display device is shown by the transparent touch panel of the handheld electronic device;
receiving a touch signal by the transparent touch panel of the handheld electronic device for obtaining a corresponding touch data;
transmitting the touch data to the display device by a wireless communication unit of the handheld electronic device; and
obtaining a relative icon displayed in the display device according to the touch data by the display device so as to execute an action corresponding to the relative icon.

7. The method as claimed in claim 6, wherein the touch data comprises a touch coordinate.

8. The method as claimed in claim 7, wherein the step of obtaining the relative icon displayed in the display device according to the touch data by the display device comprises:
transforming the touch coordinate into a display coordinate of the display device; and
obtaining the relative icon according to the display coordinate.

9. The method as claimed in claim 6, wherein the step of positioning the handheld electronic device by the positioning receiving units of the handheld electronic device and the emitting units of the display device comprises:
receiving a plurality of positioning signals from the positioning emitting units respectively by the positioning receiving units of the handheld electronic device;
respectively comparing the received positioning signals with a predetermined value of each positioning signal by the handheld electronic device;
determining that positioning is successful if each of the positioning signals is compatible with the corresponding predetermined value, and showing the entire picture displayed in the display device by the transparent touch panel of the handheld electronic device; and
indicating a notification message if at least one of the positioning signals is incompatible with the corresponding predetermined value.

10. The method as claimed in claim 9, wherein the positioning emitting units are infrared emitting units, the positioning receiving units are infrared receiving units, and the positioning signal is an infrared.

11. A system for operating a display device, comprising:
a display device, comprising:
a plurality of positioning emitting units respectively emitting a plurality of positioning signals; and
a first wireless communication unit; and
a handheld electronic device, comprising:
a transparent touch panel receiving a touch signal;
a plurality of positioning receiving units receiving the positioning signals from the positioning emitting units for positioning; and
a second wireless communication unit;
wherein the handheld electronic device obtains a corresponding touch data according to the touch signal, and the touch data is transmitted to the display device by the second wireless communication unit;
wherein the display device receives the touch data by the first wireless communication unit, and obtains a relative icon displayed in the display device according to the touch data so as to execute an action corresponding to the relative icon.

12. The system as claimed in claim 11, wherein after the positioning receiving units of the handheld electronic device receives the positioning signals from the positioning emitting units respectively, the handheld electronic device compares the received positioning signals with a predetermined value of each positioning signals respectively; it is determined that positioning is successful if each of the positioning signals is compatible with the corresponding predetermined value, the handheld electronic device shows a picture displayed in the display device by the transparent touch panel; the handheld electronic device indicates a notification message if at least one of the positioning signals is incompatible with the corresponding predetermined value.

13. The system as claimed in claim 11, wherein the touch data comprises a touch coordinate.

14. The system as claimed in claim 13, wherein after the touch data is received by the first wireless communication unit of the display device, the display device transforms the touch coordinate into a display coordinate of the display device, so as to obtain the relative icon according to the display coordinate.

15. The system as claimed in claim 11, wherein the positioning emitting units are infrared emitting units, the positioning receiving units are infrared receiving units, and the positioning signal is an infrared.
